(19) United States
(12) Patent Application Publication
(10) Pub. No.: US 2026/0185559 A1
(43) Pub. Date: Jul. 2, 2026

(54) HYBRID MAGNETIC-FOIL BEARING SYSTEM WITH PEDESTAL STRUCTURE

(71) Applicant: KOREA INSTITUTE OF SCIENCE AND TECHNOLOGY, Seoul (KR)

(72) Inventors: Yong Bok LEE, Seoul (KR); Yunseok HA, Seoul (KR); Yeong-Do LEE, Seoul (KR)

(73) Assignee: KOREA INSTITUTE OF SCIENCE AND TECHNOLOGY, Seoul (KR)

(21) Appl. No.: 19/428,798

(22) Filed: Dec. 22, 2025

(30) Foreign Application Priority Data
Dec. 31, 2024 (KR) 10-2024-0201989

(51) Int. Cl. F16C 32/04; F16C 17/02

(52) U.S. Cl. CPC F16C 32/0402; F16C 17/024

(57) ABSTRACT

The present disclosure relates to a hybrid bearing that effectively combines load-bearing capacity of a magnetic bearing and damping performance of a foil bearing by installing a pedestal between poles of the magnetic bearing and coupling the foil bearing inside the pedestal, thereby eliminating restrictions on thickness and height of foils and maintaining a constant gap between the magnetic bearing and a rotating shaft.

### CROSS-REFERENCE TO RELATED APPLICATIO N

This application claims priority to and the benefit of Korean Patent Application No. 10-2024-0201989 filed in the Korean Intellectual Property Office on Dec. 31, 2024.

### TECHNICAL FIELD

The present disclosure relates to a hybrid magnetic-foil bearing that effectively combines a load-bearing capacity of a magnetic bearing and a damping performance of a foil bearing by installing a pedestal between poles of the magnetic bearing and coupling the foil bearing on the pedestal to support a rotating shaft in a rotating machine without contact.

### BACKGROUND

In the field of conventional rotating machinery, various types of bearings have been used to support high-speed rotating bodies, such as turbines, compressors, and motors.

In particular, non-contact bearings are essential to reduce friction and wear caused by a mechanical contact during high-speed rotation. Magnetic bearings and air foil bearings are widely used.

The magnetic bearing uses an electromagnetic force to levitate and support a rotating shaft, thereby providing the advantages of a high load-bearing capacity and active vibration control.

However, the magnetic bearing has a disadvantage in that it cannot support the rotating body when the power supply is interrupted or a problem occurs in a control system, so a separate backup bearing is required.

Air foil bearings use an aerodynamic pressure generated during high-speed rotation to support a rotating shaft, thereby providing the advantages of a simple structure, easy maintenance, and no need for a separate control system.

The air foil bearings also have the effect of damping vibration through elastic deformation of a foil. However, the air foil bearings have limitations in which a load-bearing capacity may lack at a low speed and excessive deformation of the foil may occur under high load conditions.

To overcome these limitations, hybrid bearings have been developed, combining the advantages of both the magnetic bearing and the air foil bearing.

FIG. 1 illustrates a simplified cross-section of the structure of a first-generation hybrid bearing (conventional technology).

The first-generation hybrid bearing adopted a structure in which a bump foil 20 and a top foil 30 were sequentially inserted directly into the interior of a magnetic bearing 10.

However, this structure requires the bump foil 20 to be installed in a limited space (approximately 0.7 to 1.0 mm) between the magnetic bearing 10 and a rotating shaft 40, which causes serious constraints on thickness and height of the bump foil 20.

Due to the spatial constraints, the first-generation hybrid bearing has the following problems.

First, the limited thickness of the bump foil makes it difficult to secure the sufficient load-bearing capacity.

Second, the limited height of the bump foil reduces damping performance.

Third, since the excessively thin bump foil must be used, it is difficult to manufacture the foil bearing with uniform quality.

Fourth, as illustrated in FIG. 2, performance of the bearing may be reduced due to sagging generated in the thin top foil.

### PRIOR ART DOCUMENT

### Patent Document

Korean Patent Application Publication No. 10-2010-0048325

### SUMMARY

A technical object of the present disclosure is to provide a hybrid magnetic-foil bearing that improves a load-bearing capacity and damping performance, facilitates the production of a foil bearing with uniform quality, and prevents sagging of a foil by installing a pedestal between poles of a magnetic bearing and coupling the foil bearing on the pedestal to thereby eliminating restrictions on thickness and height of the foil.

In order to solve the above-described technical problems, a hybrid magnetic-foil bearing supporting a rotating shaft according to an embodiment of the present disclosure comprises a magnetic electrode part in which a plurality of poles wound around a coil are arranged in a circumferential direction; a pedestal including mounting parts, each of which is positioned between every two adjacent poles of the plurality of poles and has a groove shape inward; a bump foil accommodated in the mounting part; and a top foil installed on the bump foil and facing the rotating shaft.

The bump foil may have a wavy cross section and entirely have a plate strip shape.

A depth of the mounting part may be less than a height of the bump foil. The number of bump foils may be one less than the number of poles.

A diameter of the pedestal may be greater than a diameter of the magnetic electrode part. The bump foil and the top foil may be formed of a material with a relative permeability close to 1.

The present disclosure provides a structure in which a pedestal is installed between poles of a magnetic bearing and a bump foil and a top foil are coupled on the pedestal so that thickness and height of foils can be freely designed without affecting a gap between the magnetic bearing and a rotating shaft, thereby improving load-bearing capacity and damping performance of a foil bearing and enabling the production of the foils with uniform quality, and the stiffness and damping of the magnetic bearing and the foil bearing are combined in parallel to improve the overall performance of the system.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 illustrates a simplified cross-section of a structure of a hybrid bearing according to a prior art.

FIG. 2 illustrates a sagging problem generated in a thin top foil.

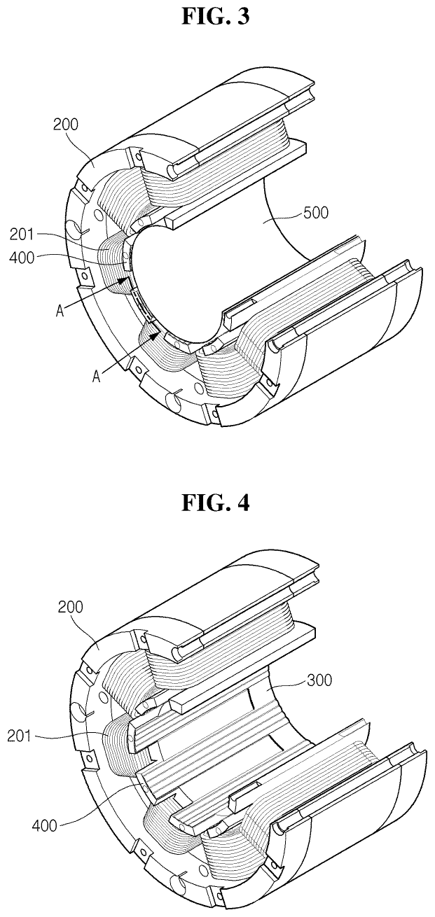

FIGS. 3 and 4 are partial perspective views of the present disclosure, and FIG. 4 illustrates that a top foil is removed.

FIG. 5 is an exploded perspective view of the present disclosure.

FIG. 6 is a cross-sectional view taken along line A-A of FIG. 3.

FIG. 7 illustrates that stiffness and damping of a magnetic bearing and stiffness and damping of an air foil bearing are in parallel combination.

FIG. 8 illustrates a schematic configuration of a test equipment for a performance test of a hybrid magnetic-foil bearing.

FIGS. 9 and 10 illustrate experimental results.

### DETAILED DESCRIPTION

Reference will now be made in detail to embodiments of the present disclosure, examples of which are illustrated in the accompanying drawings.

Detailed descriptions of known arts will be omitted if such may mislead the gist of embodiments of the present disclosure. In addition, throughout the present disclosure, “comprising” a certain component means that other components may be further comprised, not that other components are excluded, unless otherwise stated.

The terms including an ordinal number such as first, second, etc. may be used to describe various components, but the components are not limited by such terms.

The terms may be used only for the purpose of distinguishing one component from other components.

For example, without departing from the scope of the present disclosure, a first component may be referred to as a second component, and similarly, a second component may also be referred to as a first component.

The terms used in the present disclosure are for the purpose of describing specific embodiments and is not intended to limit the present disclosure.

A singular expression can include a plural expression as long as it does not have an apparently different meaning in context.

In the present disclosure, terms “include or comprise” or “have” should be understood to be intended to designate that illustrated features, numbers, steps, operations, components, parts or combinations thereof are present and not to preclude the existence of one or more other features, numbers, steps, operations, components, parts or combinations thereof, or the possibility of the addition thereof.

Unless otherwise specified, all of the terms which are used herein, including the technical or scientific terms, have the same meanings as those that are generally understood by a person having ordinary skill in the art to which the present disclosure pertains.

The terms defined in a generally used dictionary can be understood to have meanings identical to those used in the context of a related art, and are not to be construed to have ideal or excessively formal meanings unless they are obviously specified in the present disclosure.

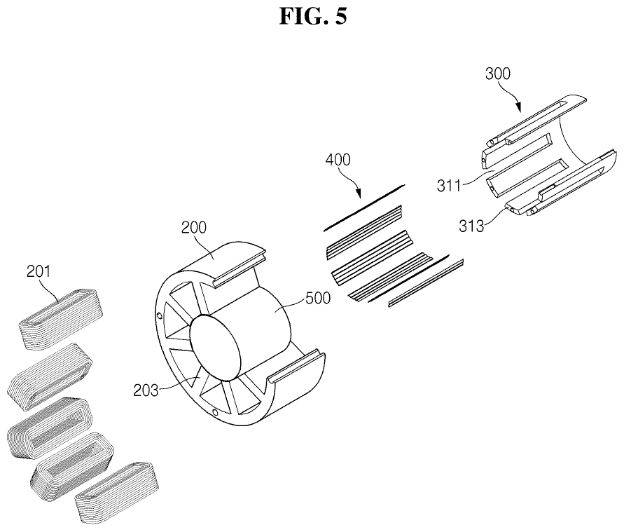

A hybrid magnetic-foil bearing according to an embodiment of the present disclosure is described below with reference to FIGS. 3 to 6.

FIGS. 3 and 4 are partial perspective views of the present disclosure, and FIG. 4 illustrates that a top foil is removed.

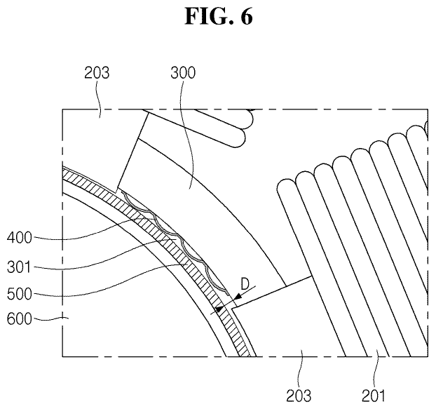

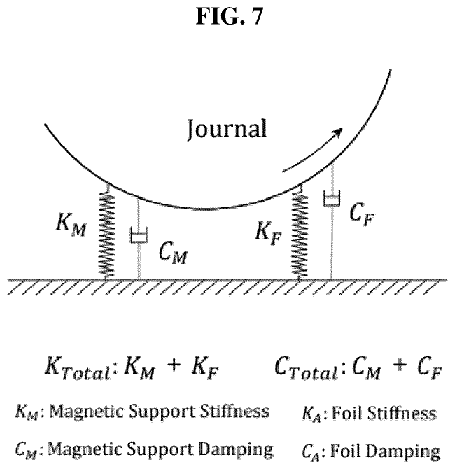

FIG. 5 is an exploded perspective view of the present disclosure. FIG. 6 is a cross-sectional view taken along line A-A of FIG. 3.

Referring to FIGS. 3 to 6, a hybrid magnetic-foil bearing supporting a rotating shaft according to an embodiment of the present disclosure includes a magnetic electrode part 200 in which a plurality of poles 203 wound around a coil 201 are arranged in a circumferential direction; a pedestal 300 including mounting parts 301, each of which is positioned between every two adjacent poles of the plurality of poles 203 and has a groove shape inward; a bump foil 400 accommodated in the mounting part 301; and a top foil 500 installed on the bump foil 400 and facing the rotating shaft.

The bump foil 400 and the top foil 500 form an air foil bearing to thereby levitate the rotating shaft using a dynamic pressure of the air generated when the rotating shaft rotates, and the magnetic electrode part 200 forms a magnetic bearing to thereby levitate the rotating shaft using a magnetic force generated by a magnetic field.

First, the magnetic electrode part 200 has a cylindrical shape and includes the plurality of poles 203 which are radially arranged inside. The coil 201 is wound around the pole 203 to form an electromagnet.

The pedestal 300 has a cylindrical shape and is inserted and coupled to the inside of the magnetic electrode part 200. To this end, the pedestal 300 includes a cut portion 311 that is inserted and coupled to the pole 203 at a portion facing the pole 203.

When the pedestal 300 is positioned inside the magnetic electrode part 200, the cut portion 311 is fitted and connected to the pole 203. Hence, a protrusion 313 formed by the cut portion 311 is positioned between every two adjacent poles among the plurality of poles 203.

The mounting part 301 with the groove shape inward is formed inside the protrusion 313, and the bump foil 400 is positioned on the mounting part 301.

The bump foil 400 has a wavy and corrugated structure and performs elastic support and damping functions.

The bump foil 400 is segmented into multiple portions, unlike the prior art. Each bump foil 400 has the same shape, for example, a plate strip shape, and thus may be easily inserted and fixed to the mounting part 301.

In this instance, a depth D of the mounting part 301 is at least smaller than a height of the bump foil 400. Therefore, even if the bump foil 400 is coupled to the mounting part 301, a portion of the bump foil 400 protrudes above the mounting part 301.

Therefore, when the top foil 500 with the cylindrical shape is positioned on the bump foil 400, the top foil 500 may be supported by the bump foil 400, and thus may operate as an air foil bearing.

The number of segmented bump foils 400 is provided corresponding to the number of poles 203. For example, if the number of poles 203 is 8, seven bump foils 400 are required.

As illustrated in FIG. 5, in the hybrid magnetic-foil bearing according to an embodiment of the present disclosure, the coil 201 is wound on each pole 203 included in the magnetic electrode part 200, the pedestal 300 is positioned inside the magnetic electrode part 200, the segmented bump foil 400 is positioned on the mounting part 301 of the pedestal 300, and the top foil 500 is positioned on the bump foil 400. As described above, the respective components are sequentially positioned and coupled.

In the hybrid magnetic-foil bearing according to an embodiment of the present disclosure, since the rotating shaft is supported by the pedestal 300 having a diameter larger than the magnetic electrode part 200, a space between the rotating shaft and the magnetic bearing due to the thickness of the bump foil 400 is not affected.

In other words, in the conventional structure, the bump foil and the top foil are positioned between the rotating shaft and the magnetic bearing, which has resulted in various problems.

However, in the present disclosure as illustrated in FIG. 6, the segmented bump foil 400 is accommodated on the mounting part 301 included in the pedestal 300, thereby solving the conventional technical problems.

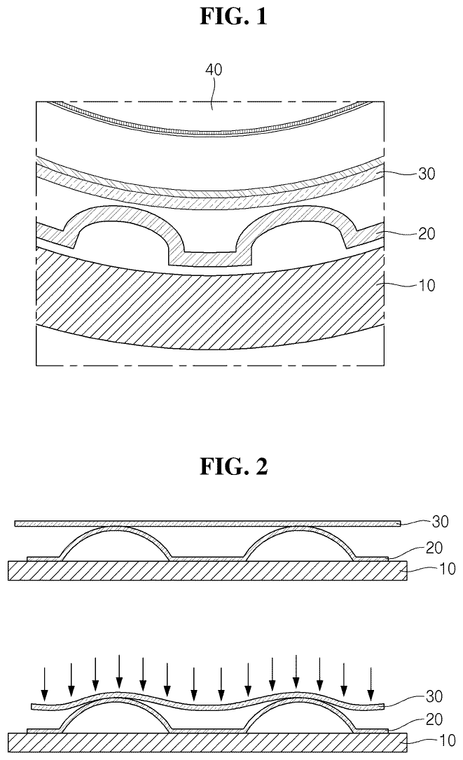

For example, when the foil bearing is inserted by setting a thickness of the top foil to 0.3 mm and a height of the bump foil to 0.55 mm, a gap between the rotating shaft and the magnetic bearing increases to 1.0 mm in the prior art (the first-generation hybrid bearing illustrated in FIG. 1), but in the present disclosure, a gap between the rotating shaft and the magnetic bearing may be maintained at 0.7 mm.

As above, if the gap between the rotating shaft and the magnetic bearing is 0.3 mm, a load-bearing capacity of the magnetic bearing may be proportional to a flux density, and the flux density may be inversely proportional to the square root of the gap. Therefore, a difference of about two times may occur, and the top foil 500 may be manufactured thick, thereby solving the sagging problem that occurs in the thin foil.

In the present disclosure, materials of the top foil and the bump foil are configured not to affect a magnetic bearing flux by using materials with a relative permeability close to 1.

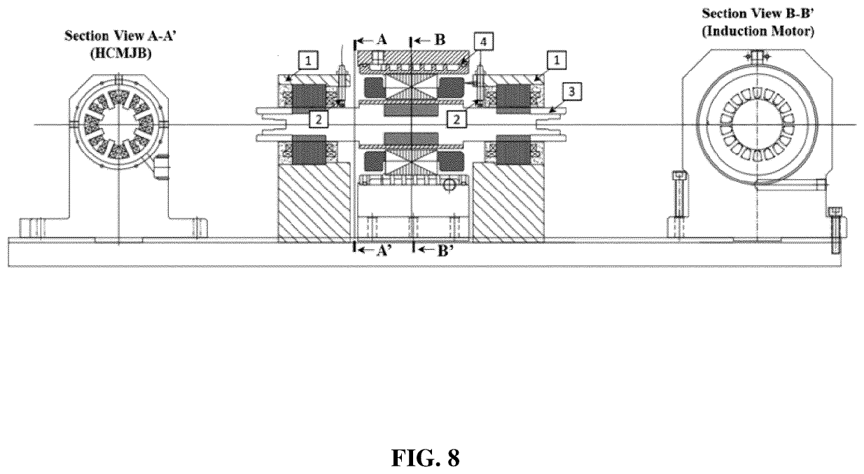

As illustrated in an example of FIG. 7, the bearing structure according to the present disclosure may be considered as a parallel combination of stiffness (K_{M}) and damping (C_{M}) of the magnetic bearing and stiffness (K_{A}) and damping (C_{A}) of the air foil bearing.

In the magnetic bearing, an electromagnetic force is used to support the rotating shaft (Journal), and a radial displacement does not occur due to an external force. The pedestal 300, which couples the bump foil 400 and the top foil 500, is inserted between the poles 203 of the magnetic electrode part 200 and is rigidly supported. Hence, the radial displacement does not occur.

As a result, the stiffness and the damping of the foil bearing and the magnetic bearing may be calculated through parallel calculation.

The parallel connection of the stiffness and the damping may increase the stiffness and damping of the entire system, thereby enhancing a radial load-bearing capacity of a turbomachinery system.

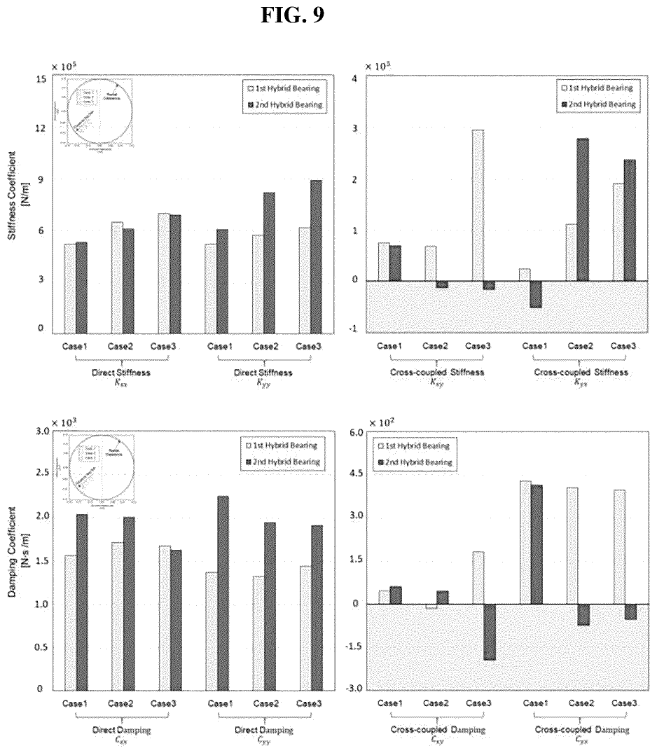

FIG. 8 illustrates a schematic configuration of a test equipment (turbo equipment) for a performance test of the above-described hybrid magnetic-foil bearing.

The test equipment includes a hybrid magnetic-foil bearing 1 having the above-described configuration, a journal position sensor 2, a rotor shaft 3, and a 20 kW induction motor 4.

To compare the performance of a hybrid bearing according to the prior art with the performance of a hybrid magnetic-foil bearing according to the present disclosure, the hybrid bearing was designed in a modular form.

To check the performance of the hybrid bearings based on stationary and rotating conditions and a levitation position, a test rotor is mounted on an induction motor. Through this, an influence of the foil bearing based on a rotational speed may be checked.

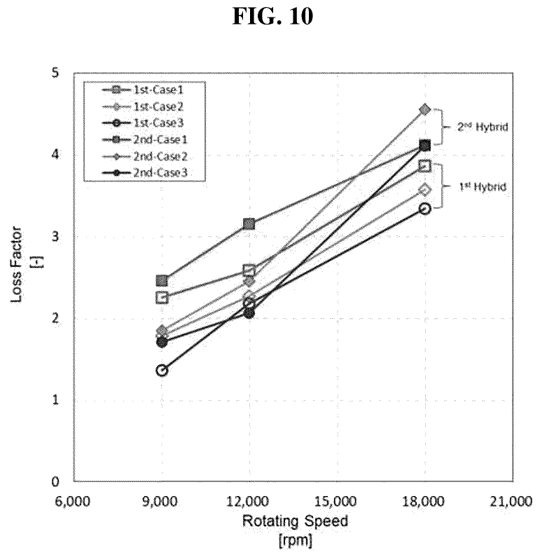

FIG. 9 illustrates experimental results according to a rotational speed of a rotor and a levitation position of a rotating shaft.

An experiment was conducted to determine dynamic characteristics of the hybrid magnetic-foil bearing according to the present disclosure based on a rotational speed (9,000 rpm, 12,000 rpm, and 18,000 rpm) of a rotor and a levitation position.

The magnetic bearing utilized PD control, and P gain was set to 7,000 A/m and D gain was set to 20 s⁻¹ to control and levitate the rotor.

To determine the dynamic characteristics, the magnetic bearing was used as an exciter, and a least squares method (LSM) was used to derive stiffness and damping.

Based on the experimental results, the dynamic characteristics of the magnetic bearing of the prior art (FIG. 1) were compared with the dynamic characteristics of the hybrid magnetic-foil bearing described in the present disclosure. Through this, the cross stiffness value that has the greatest influence on instability was derived.

As a result, when comparing the present disclosure with the prior art, it was confirmed that the damping capacity was improved in addition to an increase in the stiffness due to the thickness of the top foil.

FIG. 10 illustrates results of a lateral vibration suppression experiment for thrust bearing control.

In order to check the structural damping of the present disclosure, a loss factor was evaluated, and the loss factor can be derived through the stiffness, damping, and rotational speed derived through the existing dynamic characteristics.

As a result of comparing the loss factors affecting the damping, it can be confirmed that the hybrid magnetic-foil bearing structure of the present disclosure effectively dissipates energy, i.e., has an excellent damping effect.

As described above, the present disclosure has been examined focusing on its various embodiments. A person with ordinary skills in the technical field to which the present disclosure pertains will be able to understand that the various embodiments can be implemented in modified forms within the scope of the essential characteristics of the present disclosure.

Therefore, the disclosed embodiments are to be considered illustrative rather than restrictive. The scope of the present disclosure is shown in the claims rather than the foregoing description, and all differences within the scope should be construed as being included in the present disclosure.

What is claimed is:

1. A hybrid magnetic-foil bearing supporting a rotating shaft comprising:
a magnetic electrode part in which a plurality of poles wound around a coil are arranged in a circumferential direction;
a pedestal including mounting parts, each of which is positioned between every two adjacent poles of the plurality of poles and has a groove shape inward;
a bump foil accommodated in the mounting part; and
a top foil installed on the bump foil and facing the rotating shaft.

2. The hybrid magnetic-foil bearing of claim 1, wherein the bump foil has a wavy cross section and entirely has a plate strip shape.

3. The hybrid magnetic-foil bearing of claim 1, wherein a depth of the mounting part is less than a thickness of the bump foil.

4. The hybrid magnetic-foil bearing of claim 1, wherein a number of the bump foils is one less than a number of the poles.

5. The hybrid magnetic-foil bearing of claim 1, wherein a diameter of the pedestal is greater than a diameter of the magnetic electrode part.

6. The hybrid magnetic-foil bearing of claim 1, wherein the bump foil and the top foil are formed of a material with a relative permeability close to 1.
